(19) United States
(12) Patent Application Publication
(10) Pub. No.: US 2026/0110906 A1
(43) Pub. Date: Apr. 23, 2026

(54) See-through Display and Lens

(71) Applicant: Liqxtal Technology Inc., Tainan city (TW)

(72) Inventors: Hung-Shan Chen, Tainan City (TW); Chia-Ming Chang, Tainan City (TW); Sung-Nan Chen, Tainan City (TW)

(73) Assignee: Liqxtal Technology Inc., Tainan City (TW)

(21) Appl. No.: 19/237,036

(22) Filed: Jun. 13, 2025

Related U.S. Application Data
(60) Provisional application No. 63/711,141, filed on Oct. 23, 2024.

(51) Int. Cl. G02B 27/01

(52) U.S. Cl. CPC G02B 27/0172; G02B 2027/0178

(57) ABSTRACT

A see-through display, comprising: a frame; a controller, disposed on the frame, configured to transmit a control signal; and a lens, disposed on the frame, comprising: a polarization component, configured to confine a polarization state of an ambient light; a partially reflecting mirror component, configured to reflect and transmit the ambient light, comprising: a substrate; and a coating layer; a polarization converter, disposed between the polarization component and the partially reflecting mirror component, configured to convert the polarization state of the ambient light passing through the polarization component according to the control signal; and an electrode, disposed between the polarization converter and the substrate, configured to receive the control signal.

### CROSS REFERENCE TO RELATED APPLICATIONS

This application claims the benefit of U.S. Provisional Application No. 63/711,141, filed on Oct. 23, 2024. The content of the application is incorporated herein by reference.

### BACKGROUND OF THE INVENTION

### 1. Field of the Invention

The present invention relates to a see-through display, and more particularly, to a see-through display that can display images at one side while the effecting to the user's vision from the other side is acceptable.

### 2. Description of the Prior Art

Nowadays, virtual platforms are well-developed and widely used for exchanging information. If a wearable device could bridge the gap between virtual and real-life interactions, it could enhance the wearer's connection when using the virtual platforms.

Glasses are a common accessory in daily life and are well-suited to serve as an interaction medium for wearable device. However, current methods for displaying images on glasses (such as using semi-transparent coating lenses or perforated opaque lenses) can only display static images and cannot dynamically change the images. Additionally, the displayed images may interfere with the wearer's vision. As such, one of the goals of the industry is to develop glasses that can display images without obstructing the wearer's vision.

### SUMMARY OF THE INVENTION

The present invention is to provide a see-through display and a lens to solve the above problems.

The present invention provides a see-through display, comprising: a frame; a controller, disposed on the frame, configured to transmit a control signal; and a lens, disposed on the frame, comprising: a polarization component, configured to confine a polarization state of an ambient light; a partially reflecting mirror component, configured to reflect and transmit the ambient light, comprising: a substrate; and a coating layer; a polarization converter, disposed between the polarization component and the partially reflecting mirror component, configured to convert the polarization state of the ambient light passing through the polarization component according to the control signal; and an electrode, disposed between the polarization converter and the substrate, configured to receive the control signal.

The present invention provides a lens, for a see-through display, comprising: a polarization component, configured to confine a polarization state of an ambient light; a partially reflecting mirror component, configured to reflect and transmit the ambient light, comprising: a substrate; and a coating layer; a polarization converter, disposed between the polarization component and the partially reflecting mirror component, configured to convert the polarization state of the ambient light passing through the polarization component according to a control signal; and an electrode, disposed between the polarization converter and the substrate, configured to receive the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a user interaction system according to an embodiment of the present invention.

FIG. 2 shows schematic diagrams of visual states of a front side and a back side of an electrical controlling eyewear shown in FIG. 1 according to an embodiment of the present invention.

FIG. 3 is a schematic diagram of the electrical controlling eyewear shown in FIG. 1 according to the embodiment of the present invention.

FIG. 4 is a schematic diagram of a lens of a see-through display according to an embodiment of the present invention.

FIG. 5A shows schematic diagrams of various shapes of each pixel of the polarization converter according to an embodiment of the present invention.

FIG. 5B shows schematic diagrams of various patterns of a display area and a non-display area according to an embodiment of the present invention.

FIG. 6 is a schematic diagram of a partially reflecting mirror component according to an embodiment of the present invention.

FIG. 7 is a schematic diagram of a partially reflecting mirror component according to another embodiment of the present invention.

FIG. 8 is a schematic diagram of a partially reflecting mirror component according to another embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

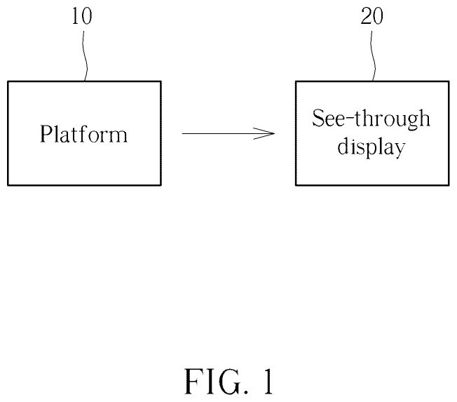

Please refer to FIG. 1. FIG. 1 is a schematic diagram of a user interaction system 1 according to an embodiment of the present invention. As shown in FIG. 1, the user interaction system 1 includes a platform 10 and a see-through display 20. The platform 10 is coupled to the see-through display 20, and may provide display content for the see-through display 20 to show. Specifically, the display content may be various images or videos that may be dynamically displayed by the see-through display 20. It should be noted that the see-through display 20 may be implemented in the form of a window, a door, a windshield, a show case, a partition, a wall, a mask, an eyewear, etc., but not limited thereto. For clarity, in the following embodiments, the see-through display is implemented as an electrical controlling eyewear 30 as an example.

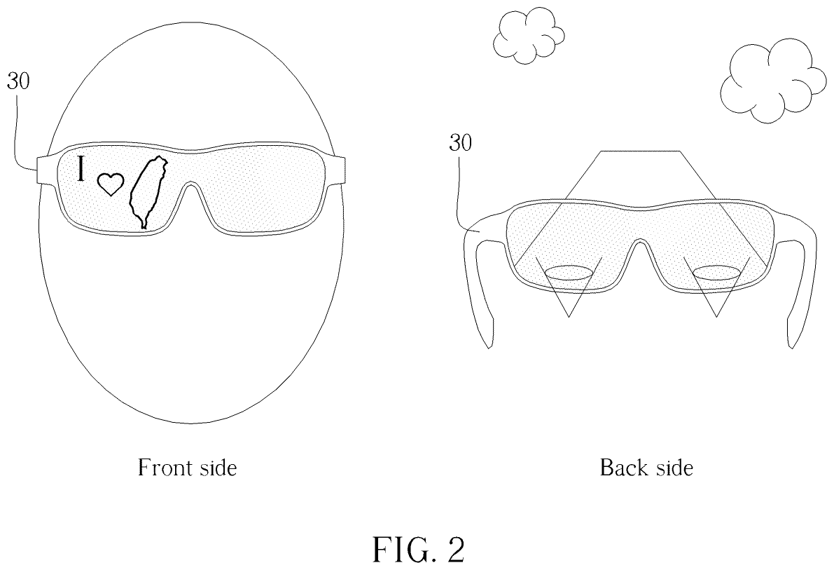

When the electrical controlling eyewear 30 displays the display content, a vision or a line of sight of a wearer (i.e. user of the electrical controlling eyewear 30) will not be affected. In other words, the display content will not interfere with the user's vision. It should be noted that, not affecting the sight of the wearer may also mean that the display content partially interferes with the sight of the wearer, but the wearer may still clearly see his/her surroundings. Please refer to FIG. 2, which shows a schematic diagram of visual states of a front side and a back side of the electrical controlling eyewear 30 according to an embodiment of the present invention. As shown in FIG. 2, a slogan is displayed on the front side of the electrical controlling eyewear 30, allowing passersby to see the slogan. On the other hand, ambient light may penetrate through the electrical controlling eyewear 30, allowing the wearer to clearly see his/her surroundings from the back side of the electrical controlling eyewear 30.

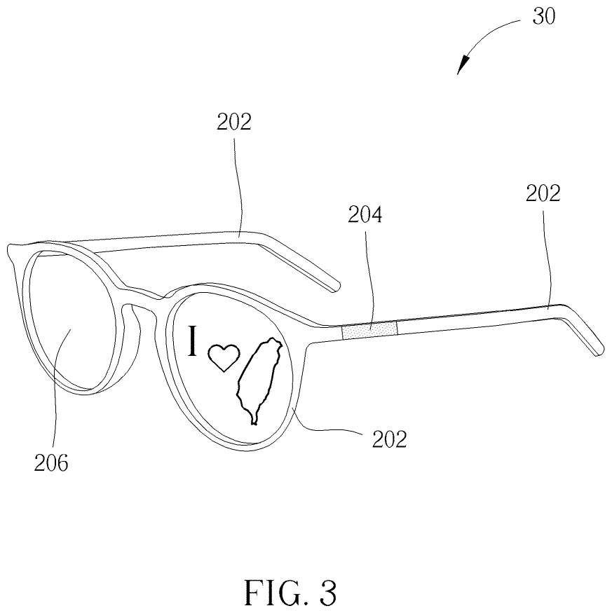

Please refer to FIG. 3. FIG. 3 is a schematic diagram of the electrical controlling eyewear 30 according to an embodiment of the present invention. As shown in FIG. 3, the electrical controlling eyewear 30 includes a frame 202, a controller 204 and a lens 206. The controller 204, disposed on the frame 202, receives the display content from the platform 10 and transmits a control signal according to the display content. The lens 206, disposed on the frame 202 and coupled to the controller 204, receives the control signal and displays the display content accordingly. It should be noted that the electrical controlling eyewear 30 of the present invention may not include the frame 202, that is, the controller 204 and the lens 206 may be configured or coupled in other forms. For example, the controller 204 is a plug-in or magnetic glasses accessory. In addition, the lens 206 may also be combined with other wearable devices, such as virtual reality devices, augmented devices, sunglasses, vision correction glasses, snow goggles, helmets or masks, but not limited thereto.

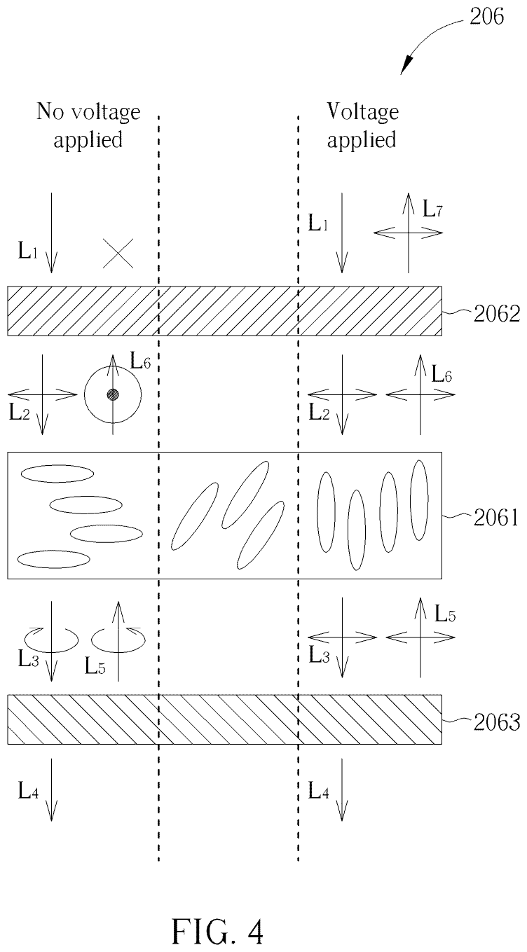

To prevent the display content displayed on the lens 206 from interfering with the ambient light passing through the lens 206, the present invention utilizes various components to control a polarization state of light. Please refer to FIG. 4. FIG. 4 is a schematic diagram of a see-through display of the lens 206 according to an embodiment of the present invention. The lens 206 includes a polarization converter 2061 disposed between a polarization component 2062 and a partially reflecting mirror component 2063. The polarization component 2062 confines the polarization state of the ambient light, the partially reflecting mirror component 2063 reflects and transmits the ambient light, and the polarization converter 2061 converts the polarization state of the ambient light passed through the polarization component 2062. It should be noted that at least one of the polarization component 2062, the partially reflecting mirror component 2063 and the polarization converter 2061 is a liquid crystal panel with active matrix connected to the controller 204 for displaying the display content according to the control signal. In an embodiment, as shown in FIG. 4, when the polarization converter 2061 displays the display content according to the control signal and ambient light L1 hits the polarization component 2062 of the lens 206, the ambient light L1 passes through three components to become transmitted lights L2, L3 and L4 respectively. In addition, part of the transmitted light L3 is reflected by the partially reflecting mirror component 2063 and passes through the polarization converter 2061 and the polarization component 2062, as shown by a reflected light L5 and transmitted lights L6 and L7 in FIG. 4. In this way, the wearer may see the transmitted light L4—that is, the wearer may see his/her surroundings (e.g. roads and scenery) from the back side of the electrical controlling eyewear 30, as shown in FIG. 2.

Furthermore, the controller 204 may use the control signal to apply a voltage to the polarization converter 2061, causing the liquid crystals in the polarization converter 2061 to change to a first arrangement. In detail, the ambient light L1 is polarized into the transmitted light L2 with a linear polarization state (as indicated by double arrow on the transmitted light L2 in FIG. 4). When the voltage is applied to the polarization converter 2061, as shown on the right part of FIG. 4, the first arrangement of the liquid crystals does not change the polarization state of the transmitted light L2. Specifically, the transmitted light L3 has the linear polarization state, and the reflected light L5 and the transmitted lights L6 and L7 also have the linear polarization state. In this way, the passersby may see the transmitted light L7 with the linear state—that is, the display area of the polarization converter 2061 has high reflectivity to the front side. It should be noted that the reflectivity on the front side changes with the localize optical modulation of the liquid crystal in the polarization converter 2061, thereby displaying the display content. While displaying content, the transmittance of the lens changes very little.

On the contrary, the controller 204 may instruct that no voltage be applied to the polarization converter 2061 through the control signal (as shown on the left part of FIG. 4), causing the liquid crystals in the polarization converter 2061 to change to a second arrangement. In detail, the ambient light L1 is polarized into the transmitted light L2 with the linear state. When no voltage is applied to the polarization converter 2061, as shown on the left part of FIG. 4, the second arrangement of the liquid crystals may change the polarization state of the transmitted light L2. Specifically, the transmitted light L3 has either a left-handed circular polarization state or a right-handed circular polarization state, and the reflected light L5 has either the right-handed circular polarization state or the left-handed circular polarization state accordingly. When the reflected light L5 with either the right-handed circular polarization state or the left-handed circular polarization state passes through the polarization converter 2061 with no voltage applied, the transmitted light L6 has a linear polarization state orthogonal to the transmitted light L2. When the transmitted light L6 with the linear polarization state hits the polarization component 2062, the transmitted light L6 with the linear polarization state cannot pass through the polarization component 2062—meaning the display area of the polarization converter 2061 has low reflectivity to the front side. It should be noted that changes in the polarization state caused by variously polarized lights hitting different components are well known in the art and will not be repeated here. In addition, the above-mentioned polarization state control method is only one embodiment, and other embodiments of the present invention may utilize other polarization state modulation methods, and those skilled in the art may make appropriate adjustments according to the system requirements. For example, the polarization component 2062 may generate left-handed or right-handed polarized light, so that the transmitted light L6 is dark when the liquid crystal of the polarization converter 2061 is vertical, and the transmitted light L6 is bright when the liquid crystal of the polarization converter 2061 is horizontal.

It should be noted that FIG. 4 only shows one embodiment of the present invention and those skilled in the art may make appropriate adjustments according to the system requirements. For example, the see-through display may further include a tinting component adjacent to or integrated with the partially reflecting mirror component 2063. The tinting component may regulate a transmittance and a reflectivity of the lens 206, allowing the electrical controlling eyewear 30 to function as sunglasses for the wearer. For example, the see-through display may further include a diffusor to increase the viewing angle of the display content displayed on the electrical controlling eyewear 30. The diffusor may be a surface with micro structure such as bumps, slants, squares. The surface may be integrated with the partially reflecting mirror. The diffusor can also be a film with micro patterned refractive index distribution.

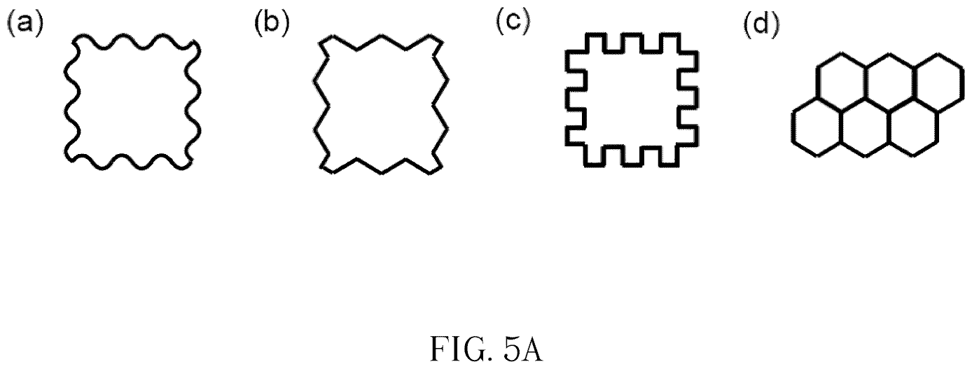

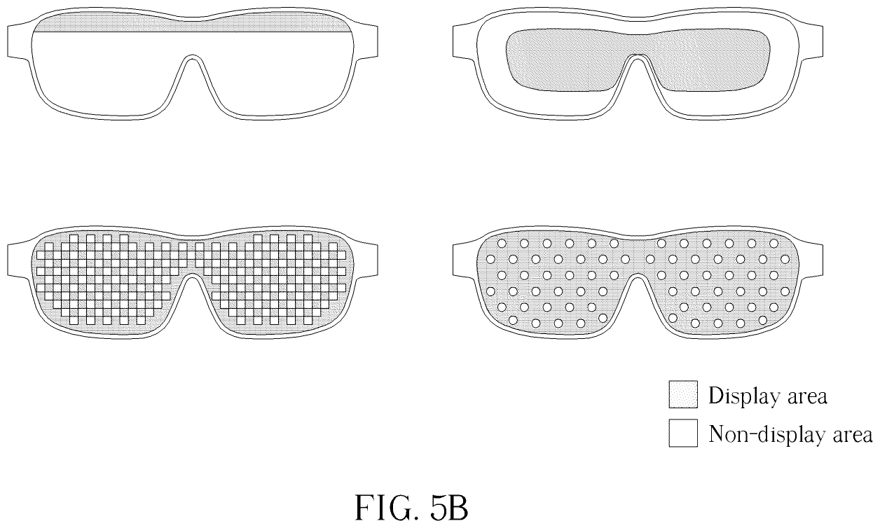

On the other hand, the polarization converter 2061, the polarization component 2062 and the partially reflecting mirror component 2063 may have various implementations, as long as the basic functions of each component may be realized, which is within the scope of the present invention. For example, the polarization component 2062 may be a polarizer, a color filter, a wave-plate, an anti-reflection film, an anti-smudge film, an angular attenuation filter or a combination of the above components. It should be noted that the above components are not limited to the polarization component 2062 and may be added at any position in the lens, and the characteristics of the above components may be configured graphically or electronically controlled according to the pixel shape and position. A material of the polarization component 2062 includes iodine or dye-based substance. The polarization converter 2061 may be an active matrix liquid crystal panel or a passive matrix liquid crystal panel, an aperture ratio of the polarization converter 2061 is higher than 50%, and the liquid crystal panel may integrated with touch sensors. In addition, the polarization converter 2061 may be realized by a zenithal bistable alignment or cholesteric liquid crystals to operate in a bistable state for power saving. It should be note that each pixel of the polarization converter 2061 may have a curved, sawtooth, or polygon shape, and an opaque line of the polarization converter 2061 may be thinner than 15 microns, and a size of each pixel of the polarization converter 2061 may be larger than 100 microns*100 microns. For example, FIG. 5A shows schematic diagrams of various shapes of each pixel of the polarization converter 2061. In this way, a diffraction or a screen door effect of the polarization converter 2061 may be reduced. Also, the liquid crystal panel may be configured to operate in twist nematic, electrically controlled birefringence, optically compensated bend, in-plane switching, fringe field switching, ferroelectric liquid crystal, cholesteric liquid crystal, dye-doped liquid crystal or polymer dispersed liquid crystal mode. Furthermore, the partially reflecting mirror component 2063 may be metal-coated or dielectric-coated. It should also be noted that principles behind the polarization converter 2061, the polarization component 2062 and the partially reflecting mirror component 2063 should be well known in the art, and will not be repeated here.

Furthermore, the polarization component 2062 and the partially reflecting mirror component 2063 may also be realized using various types of liquid crystals. In an embodiment, the partially reflecting mirror component 2063 may include micro structures or micro refractive index distribution that diffuses the ambient light. In another embodiment, the diffuser is directed attached to the partially reflecting mirror component. In an embodiment, the polarization component 2062 is a first liquid crystal panel with a dichroic dye, while in the lens 40, the partially reflecting mirror component 2063 is a second liquid crystal panel filled with cholesteric liquid crystal layer. In detail, an extinction ratio of the first liquid crystal layer with a dichroic dye may be electrically tunable to control a visibility of the display content and a visual brightness. By locally control the extinction ratio, the polarization component 2062 may also provide display functions. In another embodiment, the partially reflecting mirror component 2063 is a first liquid crystal panel with cholesteric liquid crystal. The reflectivity of cholesteric liquid crystal may be electrically tunable to control a visibility of the display content and a visual brightness. By locally control the reflectivity, the partially reflecting mirror component 2063 may also provide display functions. On the other hand, the liquid crystals in the cholesteric liquid crystal layer may be aligned with geometric distribution to provide additional phase modulation for the wearer's vision. In an embodiment, when the polarization converter 2061, the polarization component 2062 and the partially reflecting mirror component 2063 are realized in various types of liquid crystals, any of the polarization converter 2061, the polarization component 2062 and the partially reflecting mirror component 2063 may segment the lens 20 into a display area and a non-display area for the display content. For example, FIG. 5B shows schematic diagrams of various patterns of the display area and the non-display area according to the embodiment of the present invention.

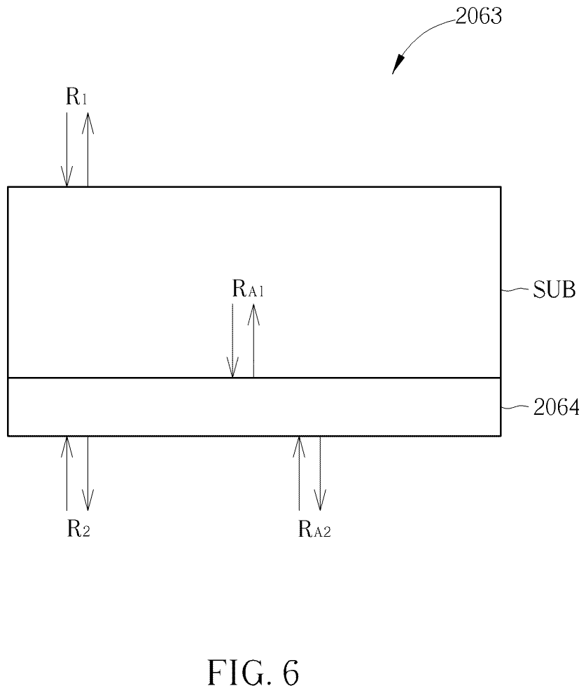

It should be noted that the partially reflecting mirror component 2063 of the electrical controlling eyewear 30 needs a certain intensity of incident light from the front side (i.e., ambient light) in order to provide sufficient light for both reflective display and see-through vision. In addition, the partially reflecting mirror component 2063 of the electrical controlling eyewear 30 needs to reduce the reflection of light incident from the back side, so that when the wearer looks at the surrounding environment through the electrical controlling eyewear 30, the wearer will not be affected by the reflected light from the back side of the electrical controlling eyewear 30. Therefore, the partially reflecting mirror component 2063 may be a two-way distinct reflection component having a front-side reflectivity and a back-side reflectivity, wherein the front-side reflectivity is greater than the back-side reflectivity. For example, the front-side reflectivity is greater than the back-side reflectivity, and more than 30%. In an embodiment, please refer to FIG. 6. FIG. 6 is a schematic diagram of a partially reflecting mirror component 2063 according to an embodiment of the present invention. The partially reflecting mirror component 2063 may include a substrate SUB and a coating layer 2064. Specifically, the coating layer 2064 has a front surface and a back surface that are in contact with materials having different refractive indices, resulting in a difference between the front-side reflectivity R_{A1} for light incident on the front surface of the coating layer 2064 and the back-side reflectivity R_{A2} for light incident on the back surface of the coating layer 2064. In addition, the substrate SUB may be made of transparent glass or transparent plastic, so that the front-side reflectivity R₁ of the partially reflecting mirror component 2063 incident with light will be equal to the front-side reflectivity R_{A1} of the coated layer 2064 incident with light, and the back-side reflectivity R₂ of the partially reflecting mirror component 2063 incident with light will be equal to the front-side reflectivity R_{A2} of the coated layer 2064 incident with light. By appropriately selecting the material of the coated layer 2064, the back-side reflectivity R₂ may be less than the front-side reflectivity R₁. In this case, when the wearer views the surrounding environment through the electrical controlling eyewear 30, the wearer will not be affected by the reflected light from the back of the electrical controlling eyewear 30, and passers-by can clearly see the display content displayed on the electrical controlling eyewear 30. It should be noted that the substrate SUB may be disposed between the coating layer 2064 and the polarizing converter 2061, or the coating layer 2064 may be disposed between the substrate SUB and the polarizing converter 2061, but is not limited thereto. Furthermore, the material of the coating layer 2064 may include a dielectric material, an optical absorbing material, a metallic material, an organic material or a conductive material. For example, the coating layer 2064 may be a single-layer coating layer, and the materials for the single-layer coating layer may include Magnesium Fluoride (MgF₂), Silicon dioxide (SiO), Aluminium oxide (Al₂O₃), Silicon Nitride (Si₃N₄), Zinc Sulfide (ZnS) or Titanium Dioxide (TiO). For example, the coating 2064 may be a multi-layer coating, and the materials of the multi-layer coating may include at least two of Magnesium Fluoride (MgF), Silicon dioxide (SiO), Aluminium oxide (Al₂O₃), Silicon Nitride (Si₃N₄), Zinc Sulfide (ZnS), Titanium Dioxide (TiO₂), Cerium Trifluoride (CeF₃), Zirconium Dioxide (ZrO₂) and Tantalum Pentoxide (Ta₂O₅).

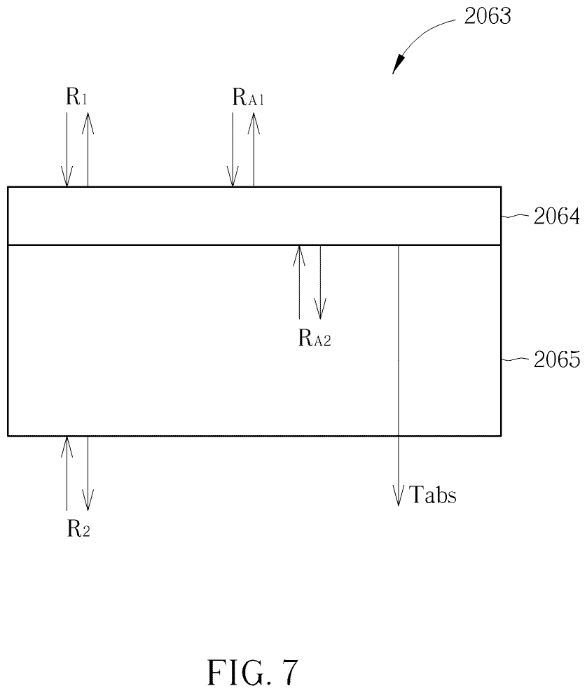

In another embodiment, please refer to FIG. 7. FIG. 7 is a schematic diagram of an embodiment of the partially reflecting mirror component 2063. In the embodiment, the partially reflecting mirror component 2063 may include a light absorbing layer 2065 and a coating layer 2064. Specifically, the coating layer 2064 has a front surface and a back surface that are in contact with materials having different refractive indices, resulting in a difference between the front-side reflectivity R_{A1} for light incident on the front surface of the coating layer 2064 and the back-side reflectivity R_{A2} for light incident on the back surface of the coating layer 2064. In addition, the light absorbing layer 2065 has a light transmittance T_{abs}. After the light enters the back side of the partially reflecting mirror component 2063, the reflected light will pass through the light absorbing layer 2065 twice. Therefore, the front-side reflectivity R₁ of the partially reflecting mirror component 2063 incident with light will be equal to the front-side reflectivity R_{A1} of the coating layer 2064 incident with light, and the back-side reflectivity R₂ of the partially reflecting mirror component 2063 incident with light will be equal to the back-side reflectivity R_{A2} of the coating layer 2064 incident with light multiplied by square of the light transmittance T_{abs}, that is:

$${R}_{2} = {T}_{a b s}^{2} {R}_{A 2} .$$

By appropriately selecting the materials of the coating layer 2064 and the light absorbing layer 2065, the back-side reflectivity R₂ may be less than the front-side reflectivity R₁. In this case, when the wearer views the surrounding environment through the electrical controlling eyewear 30, the wearer will not be affected by the reflected light from the back of the electrical controlling eyewear 30, and passers-by can clearly see the display content displayed on the electrical controlling eyewear 30. It should be noted that the coating layer 2064 may be disposed between the light absorbing layer 2065 and the polarizing converter 2061. In addition, the light absorbing layer 2065 may be realized by dyeing the substrate SUB in FIG. 6.

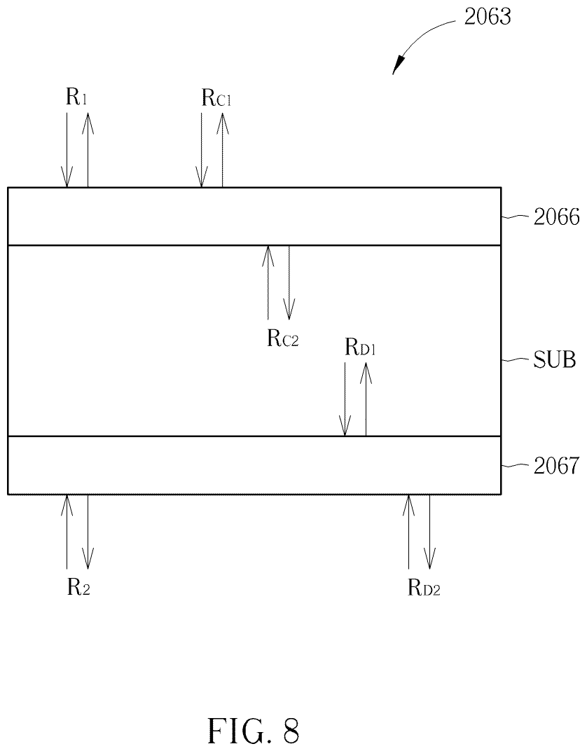

In another embodiment, please refer to FIG. 8. FIG. 8 is a schematic diagram of an embodiment of the partially reflecting mirror component 2063. In the embodiment, the partially reflecting mirror component 2063 may include the substrate SUB, a first multi-layer coating layer 2066 and a second multi-layer coating layer 2067. The substrate SUB is disposed between the first multi-layer coating layer 2066 and the second multi-layer coating layer 2067. Specifically, the first multi-layer coating layer 2066 has a front surface and a back surface that are in contact with materials having different refractive indices, resulting in a difference between a front-side reflectivity Ra for light incident on the front surface of the first multi-layer coating layer 2066 and a back-side reflectivity Res for light incident on the back surface of the first multi-layer coating layer 2066. Similarly, the second multi-layer coating layer 2067 has a front surface and a back surface that are in contact with materials having different refractive indices, resulting in a difference in the front-side reflectivity R_{D1} for light incident on the front surface of the second multi-layer coating layer 2067 and the back-side reflectivity Ros for light incident on the back surface of the second multi-layer coating layer 2067. Therefore, the front-side reflectivity R₁ of the partially reflecting mirror element 2063 and the back-side reflectivity R₂ of the partially reflecting mirror element 2063 are related to the front-side reflectivity R_{C1} and back-side reflectivity R_{C2} of the first multi-layer coating 2066 and the front-side reflectivity R_{A2} of the incident coating 2064. By appropriately selecting the materials of the first multi-layer coating 2066 and the second multi-layer coating 2067, the back reflectivity R of the partially reflecting mirror component 2063 can be less than the front reflectivity R₁ of the partially reflecting mirror component 2063. In this case, when the wearer views the surrounding environment through the electrical controlling eyewear 30, he/she will not be affected by the reflected light from the back of the electrical controlling eyewear 30, and passers-by can clearly see the display content displayed on the electrical controlling eyewear 30. It should be noted that the first multi-layer coating 2066 and the second multi-layer coating 2067 may include at least two of the following materials: Magnesium Fluoride (MgF₂), Silicon dioxide (SiO₂), Aluminium oxide (Al₂O₃), Silicon Nitride (Si₃N₄), Zinc Sulfide (ZnS), Titanium Dioxide (TiO₂), Cerium Trifluoride (CeF₃), Zirconium Dioxide (ZrO₂) and Tantalum Pentoxide (Ta₂O₅) at least two of the materials.

It should be noted that in the embodiments of FIGS. 6, 7 and 8, the present invention may adjust the composition, concentration, thickness or arrangement of the material to change the spectral distribution of the partially reflecting mirror component 2063, thereby optimizing the color performance of the electrical controlling eyewear 30. For example, when the reflection spectrum of the partially reflecting mirror component 2063 has higher value in blue and ultraviolet components, the image display on the electrical controlling eyewear 30 is blueish. Meanwhile, the blue light and ultraviolet light components in the transmission spectrum of the partially reflecting mirror component 2063 are simultaneously reduced to achieve the effect of protecting the user's eyes.

In summary, the electrical controlling eyewear of the present invention may utilize the lens including the liquid crystal panel disposed between the polarization component and the partially reflecting mirror component, and further control the transmitted light and the reflected light after the ambient light hits the lens. The partially reflecting mirror component has different reflectivity on the two sides. In this way, the brightness of the display content displayed on the front side of the electrical controlling eyewear is improved. Meanwhile, the user's vision through the electrical controlling eyewear is not affected by the reflection from the back-side.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A see-through display, comprising:
a frame;
a controller, disposed on the frame, configured to transmit a control signal; and
a lens, disposed on the frame, comprising:
a polarization component, configured to confine a polarization state of an ambient light;
a partially reflecting mirror component, configured to reflect and transmit the ambient light, comprising:
a substrate; and
a coating layer;
a polarization converter, disposed between the polarization component and the partially reflecting mirror component, configured to convert the polarization state of the ambient light passing through the polarization component according to the control signal; and
an electrode, disposed between the polarization converter and the substrate, configured to receive the control signal.

2. The see-through display of claim 1, wherein a front-side reflectivity of the partially reflecting mirror component is greater than a back-side reflectivity.

3. The see-through display of claim 1, wherein the partially reflecting mirror component further comprises a light absorbing layer, and the coating layer is disposed between the light absorbing layer and the polarization converter.

4. The see-through display of claim 1, wherein the substrate is a light absorbing layer.

5. The see-through display of claim 1, wherein the coating layer is a first multiple coating layer.

6. The see-through display of claim 5, wherein the first multiple coating layer is disposed between the substrate and the polarization converter or the substrate is disposed between the first multiple coating layer and the polarization converter.

7. The see-through display of claim 5, wherein the partially reflecting mirror component further comprises a second multiple coating layer, and the substrate is disposed between the first multiple coating layer and the second multiple coating layer.

8. A lens, for a see-through display, comprising:
a polarization component, configured to confine a polarization state of an ambient light;
a partially reflecting mirror component, configured to reflect and transmit the ambient light, comprising:
a substrate; and
a coating layer;
a polarization converter, disposed between the polarization component and the partially reflecting mirror component, configured to convert the polarization state of the ambient light passing through the polarization component according to a control signal; and
an electrode, disposed between the polarization converter and the substrate, configured to receive the control signal.

9. The lens of claim 8, wherein a front-side reflectivity of the partially reflecting mirror component is greater than a back-side reflectivity.

10. The lens of claim 9, wherein the partially reflecting mirror component further comprises a light absorbing layer, and the coating layer is disposed between the light absorbing layer and the polarization converter.

11. The lens of claim 8, wherein the substrate is a light absorbing layer.

12. The lens of claim 8, wherein the coating layer is a first multiple coating layer.

13. The lens of claim 12, wherein the first multiple coating layer is disposed between the substrate and the polarization converter or the substrate is disposed between the first multiple coating layer and the polarization converter.

14. The lens of claim 12, wherein the partially reflecting mirror component further comprises a second multiple coating layer, and the substrate is disposed between the first multiple coating layer and the second multiple coating layer.
